(19) United States
(12) Patent Application Publication
(10) Pub. No.: US 2009/0185844 A1
(43) Pub. Date: Jul. 23, 2009

(54) DOUBLE-SIDED IMAGE FORMING APPARATUS AND METHOD

(75) Inventor: Akihiko IKEGAMI, Okaya-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/351,434

(22) Filed: Jan. 9, 2009

(30) Foreign Application Priority Data
Jan. 17, 2008 (JP) 2008-007664

(51) Int. Cl. G03G 15/00

(52) U.S. Cl. 399/364

(57) ABSTRACT

A double-sided image forming apparatus includes front-side and rear-side image forming units arranged in the transporting direction in which a recording medium is transported. Each of the image forming units includes an endless belt that transports the recording medium and a recording section that records on the recording medium. The belt transfers the recording medium from one of the adjacent front-side or rear-side image forming units to the other image forming unit such that part of the recording medium is transported onto part of the belt of the other image forming unit. The recording section of each image forming unit is configured to perform recording in a single color. The image forming units are arranged so that the front and rear sides are alternately subjected to recording on a color-by-color basis in the order of the front side, the rear side, the front side, and the rear side.

### BACKGROUND

1. Technical Field

The present invention relates to a double-sided image forming apparatus including front-side image forming units and rear-side image forming units such that those units are arranged in the transporting direction in which a recording medium is transported, each unit being of a line recording type, for example, a line printer, and also relates to a double-sided image forming method.

2. Related Art

As for an example of related-art double-sided image forming apparatuses, for example, JP-A-2004-195956 discloses a line ink jet recording apparatus. In this ink jet recording apparatus, a recording medium is transported by an endless belt while being held thereon, the front side of the recording medium is subjected to recording in a recording area facing a line recording head, the recording medium is then turned upside down in a reversing path, and the turned recording medium is further transported by the belt, and the rear side of the recording medium is also subjected to recording in the recording area through the line recording head.

The endless belt is stretched between a pair of rollers and is driven by rotation of the rollers. The line recording head is disposed so as to face the flat upper surface of the endless belt stretched between the rollers. The recording medium is held on the belt by electrostatic attraction or negative pressure suction.

JP-A-2003-94615 discloses a drum printer for recording characters or images onto a recording medium through an ink jet recording head while the recording medium is attached on the outer surface of a rotating drum and is transported at constant rotational speed in order to stabilize recording-medium transporting speed during printing. The printer includes a gripping mechanism that holds the leading edge of the recording medium. The printer further includes a corona charger and a separation charger. The corona charger charges the recording medium so that the whole of the recording medium is in tight contact with the drum. To separate and eject the recording medium, the gripping mechanism is released and the separation charger is simultaneously actuated so as to discharge the recording medium. In addition, the printer includes an auxiliary mechanism, such as a vacuum belt transport, for actually ejecting the recording medium.

In the double-sided image forming apparatus disclosed in JP-A-2004-195956, after recording is carried gout on the “front side” of a recording medium, the recording medium is turned upside down and recording is then carried out on the “rear side” thereof. Accordingly, recording on the “front side” of the recording medium is performed in a “both sides identical condition” in which ink is not applied to each of the front and rear sides of the recording medium but recording on the “rear side” of the recording medium is performed in a “both sides non-identical condition” in which ink has been applied only to the “front side” of the recording medium. Disadvantageously, it is difficult to allow ink adhesion to progress evenly on both of the sides of the recording medium. The uneven ink adhesion may cause curling of the recording medium. In other words, the recording quality of the front side of the recording medium may differ from that of the rear side thereof.

In addition, although the recording medium is attracted on the belt, the belt is relatively easy to vibrate because recording is performed on part, mounted on the belt stretched between the rollers, of the recording medium. Unfortunately, ink droplets are applied to the vibrating recording medium. Furthermore, in the arrangement in which the belt is stretched between the rollers, the belt and rollers for supporting and transporting a recording medium are not expected to have a large inertia. Accordingly, a fluctuation in speed may easily occur. For those reasons mentioned above, the accuracy of position of an ink dot may easily vary. It is therefore difficult to obtain high recording quality. In double-sided recording, since a recording medium is in the above-described “both sides non-identical condition” during recording of the “rear side” of the recording medium, the recording quality of the front side of the recording medium may more easily differ from that of the rear side thereof.

The drum printer disclosed in JP-A-2003-94615 has to include a large-scale mechanism, i.e., the gripping mechanism for holding the leading edge of a recording medium. Furthermore, in order to transport a recording medium while the whole of the recording medium is being in tight contact with the drum, it is necessary to charge the recording medium through the corona charger. In order to separate the recording medium from the drum and eject the medium, it is necessary to release the gripping mechanism and simultaneously actuate the separation charger so as to discharge the recording medium. In other words, troublesome control processes are required. Furthermore, the auxiliary mechanism, i.e., the vacuum belt transport is necessary to actually eject the recording medium. The scale of the whole configuration of a recording-medium transporting system is inevitably increased.

When double-sided recording is carried out on a recording medium using the above related-art drum printer, the following issue may arise.

The printer has a structure in that two drums are arranged in contact with each other as in, for example, an offset press and the gripping mechanism transfers a recording medium to the drums. In this structure, since the two drums are in contact with each other, the recording medium is attached to the drum for rear-side recording while ink on the front side of the medium is not sufficiently dried. Disadvantageously, it results in a reduction in image quality on the front side of the medium.

### SUMMARY

An advantage of some aspects of the invention is to provide a double-sided image forming apparatus in which ink adhesion can progress evenly on both sides of a recording medium, a cause of curling of the recording medium can be therefore eliminated, and recording quality of the “front side” of the recording medium hardly differs from that of the “rear side” thereof.

According to an aspect of the invention, a double-sided image forming apparatus includes front-side image forming units and rear-side image forming units arranged in the transporting direction in which a recording medium is transported. Each of the front-side image forming units and the rear-side image forming units includes an endless belt that transports the recording medium and a recording section that performs recording on the recording medium transported on the belt. The recording medium held and transported on the belt of one of the adjacent front-side image forming unit and rear-side image forming unit is transferred to the other image forming unit such that part, passed under the recording section of the one image forming unit, of the recording medium is transported onto part of the belt of the other image forming unit, the part of the belt being upstream of the recording section of the other image forming unit. The recording section of each of the front-side image forming units and the rear-side image forming units is configured to perform recording in a single color. The front-side image forming units and the rear-side image forming units are arranged so that the front side and the rear side of the recording medium are alternately subjected to recording on a color-by-color basis in the order of the front side, the rear side, the front side, and the rear side.

According to this aspect, the recording section of each of the front-side image forming units and the rear-side image forming units is configured to perform recording in a single color. The front-side image forming units and the rear-side image forming units are arranged so that the front and rear sides of the recording medium are alternately subjected to recording on the color-by-color basis in the order of the front side, the rear side, the front side, and the rear side. In other words, recording is not performed in such a manner that recording on the “rear side” of the recording medium is performed after completion of recording on the “front side” thereof. Recording in different ink colors is performed on the color-by-color basis in the order of the front side and the rear side such that recording is performed on the “front side” and the “rear side” of the recording medium in a single color and recording is performed on the “front side” and the “rear side” thereof in another single color.

In related-art double-sided recording, recording on the “front side” of a recording medium is carried out in the both sides identical condition in which ink is not discharged to each of the front and rear sides of the recording medium but recording on the “rear side” thereof is carried out in the both sides non-identical condition in which ink has been discharged to only the “front side” of the recording medium. According to this aspect of the invention, the degree of non-identity in the both sides non-identical condition can be remarkably reduced. Consequently, ink adhesion can progress evenly on both of the front and rear sides of the recording medium, thus eliminating a cause of curling of the recording medium and reducing the difference in recording quality between the front and rear sides of the recording medium.

It is preferable that each front-side image forming unit and the following rear-side image forming unit be configured to perform recording on the front and rear sides of the recording medium in the same color.

In this case, since the “front side” and the following “rear side” of the recording medium are subjected to recording in the same color, the front and rear sides, applied with the same color ink, of the recording medium have the same degree of change in state, such as distortion or swelling, depending on the combination of the kind of ink and the type of recording medium, so that the changed states of the front and rear sides are easily cancelled out. Accordingly, when the “front side” of the recording medium is then subjected to recording with an ink of another color, the recording medium can be set in a condition close to the “both sides identical condition”. Advantageously, the difference in recording quality between the front and rear sides of the recording medium can be further reduced.

It is preferable that each of the front-side image forming units and the rear-side image forming units include a drum, a roller having a smaller diameter than the drum, the endless belt stretched between the drum and the roller, a driving source that rotates the drum to rotate the belt, and the recording section of a line recording type, the recording section facing the outer curved surface of the drum so as to perform recording on the recording medium held on part, wrapping around the drum, of the belt. The recording medium held and transported on the belt of one of the adjacent front-side image forming unit and rear-side image forming unit may be transferred to the other image forming unit such that part, passed under the recording section of the one image forming unit, of the recording medium is transported onto part of the belt of the other image forming unit, the part of the belt being upstream of the recording section of the other image forming unit and wrapping around the drum of the other image forming unit.

In this specification, the “drum” is not limited to a drum having the same configuration as that of a drum configured such that a recording medium is allowed to be in contact with the surface of the drum, the surface of the drum is used as a platen, and recording is performed on the recording medium on the surface (i.e., smoothed curved surface) of the drum. In other words, since the drum is wrapped with the belt, the drum may be configured such that recording similar to that on the surface of the drum can be performed on the surface of the belt wrapping around the drum. The drum may include a drum whose surface is not inevitably smoothed.

The following advantages are further obtained. The recording section of the line recording type performs recording on the fed recording medium on the outer surface of part, wrapping around the drum, of the belt. Since the drum has a larger diameter and a larger inertia than the roller, the drum can rotate stably in rotating at constant speed. Accordingly, part, on the belt wrapping around the drum, of the recording medium is stably transported without being vibrated or fluctuated in speed. Since recording is performed on the stably transported part of the recording medium, high recording position accuracy can be ensured and high image quality double-sided recording can be performed. In addition, since the recording medium is transported on the belt, such a transporting mechanism is simple. The mass of the drum also affects the inertia. Therefore, it is preferred to set the outer diameter of the drum in consideration of the mass thereof so that the motion of the belt is significantly affected by the drum rather than by the roller.

If a serial recording method is used, the drum has to be driven intermittently to intermittently transport a recording medium. In this case, the large inertia leads to reduced stop position accuracy. In contrast, since the recording section of the line recording type is used in this aspect, the drum may be driven at constant speed during recording. Advantageously, the recording medium can be stably transported and the above-described advantages can be obtained.

In the apparatus according to this aspect, preferably, a transfer section where the recording medium is transferred between the adjacent image forming units is provided by surface contact between the belts of the adjacent front-side image forming unit and rear-side image forming unit, the surface contact having a predetermined area extending in the transporting direction.

In this case, the transfer section where the recording medium is transferred between the image forming units is provided by surface contact between the belts of the adjacent front-side image forming unit and rear-side image forming unit, the surface contact having a predetermined area extending in the transporting direction. Accordingly, in the transfer section, the front and rear sides of the recording medium are supported by the belts. After that, the recording medium is shifted from such a both sides supported mode to a single side supported mode in which, for example, the medium is held only by the belt of the rear-side image forming unit. Consequently, the recording medium is smoothly transferred from, for example, the belt of the front-side image forming unit to the belt of the following rear-side image forming unit, thus preventing a reduction in recording quality caused by sheet transfer between the adjacent image forming units.

Preferably, all of the rear-side image forming units disposed downstream of at least the most upstream front-side image forming unit and the other front-side image forming units are each configured such that the number of drums is one and the number of rollers is two. The transfer section may be disposed between the roller, serving as a separating section that separates the recording medium, in one of the adjacent image forming units and the roller, serving as a receiving section that receives the recording medium, in the other image forming unit. An angle formed by the belt wrapping around the roller, serving as the separating section, may be an acute angle and an angle formed by the belt wrapping around the roller, serving as the receiving section, may be an obtuse angle.

In this case, all of the rear-side image forming units disposed downstream of at least the most upstream front-side image forming unit and the other front-side image forming units are each configured such that the number of drums is one and the number of rollers is two, namely, so as to include one drum and two rollers. In other words, those image forming units have a three-axis structure. Accordingly, the flexibility in design of the entire structure can be increased. Consequently, a space for arrangement of other components, e.g., a drying section which will be described later, can be easily ensured. As a matter of course, the most upstream front-side image forming unit may have the three-axis structure in which the number of drums is one and the number of rollers is two.

In addition, the transfer section is disposed between the roller, serving as the separating section that separates the recording medium, in one of the adjacent image forming units and the roller, serving as the receiving section that receives the recording medium, in the other image forming unit. The angle formed by the belt wrapping around the roller, serving as the separating section, is the acute angle and the angle formed by the belt wrapping around the roller, serving as the receiving section, is the obtuse angle. Accordingly, in a case where the recording medium, whose front side has been subjected to recording in the front-side image forming unit, enters the transfer section toward the following rear-side image forming unit, if the leading edge of the recording medium floats, the above-described obtuse-angle arrangement can easily eliminate the floating of the recording medium so that the recording medium enters the transfer section. After that, the recording medium can be easily separated from the belt of the front-side image forming unit in the exit of the transfer section by the acute-angle arrangement and be smoothly transported such that the medium is held only by the belt of the rear-side image forming unit.

It is preferable that the apparatus further include a drying section disposed between the recording section of one of the adjacent image forming units and the roller, serving as the receiving section, of the other image forming unit.

In this case, since the recorded side of the recording medium is dried by the drying section and the next recording is performed on the recording medium, a reduction in recording quality can be prevented.

It is preferred that the apparatus further include a first negative pressure section that attracts the recording medium to at least part, wrapping around the drum, of the belt by negative pressure suction. Each of the front-side image forming units and the rear-side image forming units may include a second negative pressure section and a third negative pressure section in a space provided on the inside of the belt and on the outside of the drum, the second negative pressure section attracting the recording medium to the outer surface of part, located upstream of the part wrapping around the drum, of the belt by negative pressure suction, the third negative pressure section attracting the recording medium to the outer surface of part, located downstream of the part wrapping around the drum, of the belt by negative pressure suction. The third negative pressure section may be separated from the first and second negative pressure sections through a partition. A space enclosed by at least the partition and the belt may be substantially hermetically sealed.

In this case, since the recording medium is attracted to at least part, wrapping around the drum, of the belt by suction under negative pressure through the first negative pressure section, the recording medium can be effectively prevented from shifting relative to the outer curved surface of the drum driven stably. Advantageously, shifting of the recording medium relative to the drum (or the belt) can be effectively prevented, so that high recording position accuracy can be easily obtained.

In addition, since the front-side image forming units and the rear-side image forming units each include the second and third negative pressure sections that attract the recording medium to the outer surface of the belt by negative pressure suction, the recording medium can be transported on the belt while being held tightly on the belt and the transfer of the recording medium can be smoothly implemented.

Furthermore, the third negative pressure section is separated from the first and second negative pressure sections through the partition. In particular, therefore, in the arrangement of the components including the drying section, heat applied to the belt for drying can be eliminated due to suction exhaust stream, serving as a negative pressure generating source of the third negative pressure section, so that the heat is not propagated toward the drum. Consequently, unnecessary heat can be prevented from propagating to the drum. Thus, any trouble, such as nozzle clogging, caused by propagation of unnecessary heat through the recording section located near the drum can be prevented.

It is preferred that each image forming unit further include a sensor that detects the position of the recording medium such that the sensor is disposed upstream of the recording section.

In this case, each image forming unit can independently grasp the leading edge of a recording medium using the sensor before start of recording. Advantageously, a recording position can be prevented from being shifted.

According to another aspect of the invention, there is provided a double-sided image forming apparatus for discharging different kinds of liquids to each of the front and rear sides of a recording medium to form images. The apparatus includes a first discharging unit that discharges one of the liquids to the front side of the recording medium, a second discharging unit that discharges one of the liquids to the rear side of the recording medium processed through the first discharging unit, a third discharging unit that discharges one of the liquids to the front side of the recording medium processed through the second discharging unit, the one liquid being not discharged by the first discharging unit, and a fourth discharging unit that discharges one of the liquids to the rear side of the recording medium processed through the third discharging unit, the one liquid being not discharged by the second discharging unit.

According to further another aspect of the invention, there is provided double-sided image forming method for discharging different kinds of liquids to the front and rear sides of a recording medium to form images. The method includes the steps of (a) discharging one of the liquids to the front side of the recording medium, (b) discharging one of the liquids to the rear side of the recording medium processed in step (a), (c) discharging one of the liquids to the front side of the recording medium processed in step (b), the one liquid being not discharged in step (a), and (d) discharging one of the liquids to the rear side of the recording medium processed in step (c), the one liquid being not discharged in step (b).

### BRIEF DESCRIPTION OF THE DRAWINGS

The invention will be described with reference to the accompanying drawings, wherein like numbers reference like elements.

FIG. 1 is a schematic sectional side elevation view of a substantial portion of a double-sided image forming apparatus according to a first embodiment of the invention.

FIG. 2 is a plan view of a first front-side recording unit in FIG. 1.

FIG. 3 is a schematic sectional side elevation view of a first front-side recording unit in accordance with a second embodiment of the invention.

FIG. 4 is a schematic side view of the first front-side recording unit in accordance with the second embodiment.

FIG. 5 is a schematic plan view of the first front-side recording unit in accordance with the second embodiment.

FIG. 6 is a schematic sectional side elevation view of a double-sided image forming apparatus according to a third embodiment of the invention.

### DESCRIPTION OF EXEMPLARY EMBODIMENTS

### First Embodiment

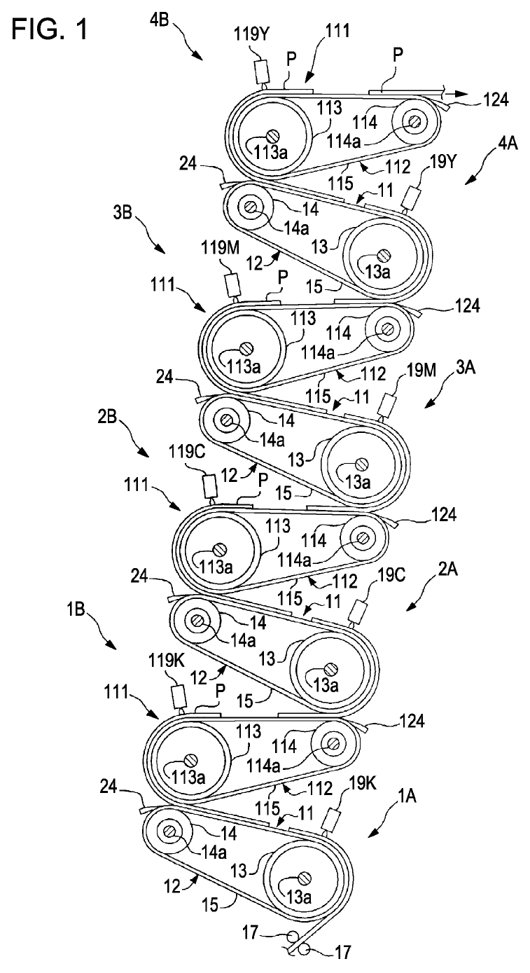

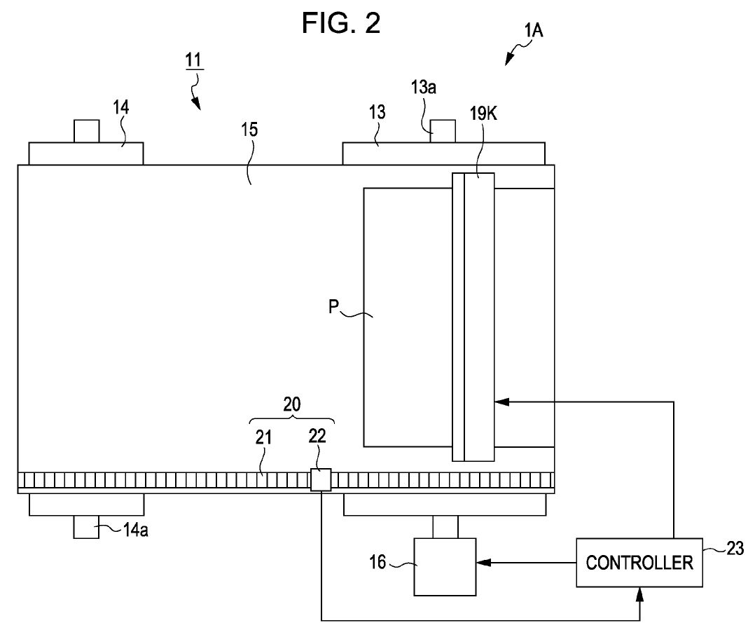

A first embodiment of the invention will be described with reference to FIGS. 1 and 2.

FIG. 1 is a schematic sectional side elevation view of a substantial portion of a double-sided image forming apparatus including front-side recording units and rear-side recording units which are of an ink jet type and of a line recording type. FIG. 2 is a plan view of one front-side recording unit in FIG. 1. In FIG. 1, a recording sheet of paper (hereinafter, referred to as “recording sheet”) is transported upwardly from below to the left, to the right, and so on. FIG. 2 illustrates a recording sheet which is being transported just after the start of printing.

Referring to FIG. 1, the double-sided image forming apparatus according to this embodiment includes a first front-side recording unit 1A, a first rear-side recording unit 1B, a second front-side recording unit 2A, a second rear-side recording unit 2B, a third front-side recording unit 3A, a third rear-side recording unit 3B, a fourth front-side recording unit 4A, and a fourth rear-side recording unit 4B in that order from upstream to downstream in the sheet transporting direction in which the recording sheet is transported. In this embodiment, the four front-side recording units 1A, 2A, 3A, and 4A and the four rear-side recording units 1B, 2B, 3B, and 4B have the same basic structure and correspond to four different ink colors. The basic structure will be described below.

As shown in FIGS. 1 and 2, a line printer (hereinafter, simply referred to as “printer”) 11, serving as the first front-side recording unit 1A, includes a belt transport 12 for transporting a recording sheet P. The belt transport 12 has a driving drum (hereinafter, simply referred to as “drum”) 13 disposed on the upstream side in the sheet transporting direction, a driven roller (hereinafter, referred to as “roller”) 14 placed on the downstream side in the sheet transporting direction, and an endless belt (hereinafter, simply referred to as “belt”) 15 stretched between the drum 13 and the roller 14. A rotating shaft 13a of the drum 13 and a rotating shaft 14a of the roller 14 are rotatably supported by bearings (not shown) respectively.

The drum 13 has an outer diameter and surface configuration similar to those of a related-art drum used for performing recording on a recording sheet P on the surface (smoothly curved) of the drum while the sheet is in contact with the surface of the drum and the drum surface is used as a platen. Certainly, the drum 13 is not limited to this configuration. Since the drum 13 is used while being wrapped with the belt 15, the drum 13 may have a configuration in which recording can be performed on the surface of the belt 15 wrapping around the drum 13 in a manner similar to that on the above-described smoothly curved surface of the drum. Therefore, it is not necessary that the drum 13 have a smooth surface.

The drum 13 is connected to an output shaft of an electric motor 16 shown in FIG. 2 directly or through a speed reducing mechanism (not shown) such that the electric motor 16 can transfer power to the drum 13. When the electric motor 16, serving as a driving source, is driven forward, the drum 13 is rotated, so that the belt 15 rotates in the direction in which the recording sheet P can be transported from the upstream side to the downstream side. A pair of gate rollers 17, constituting a feeder, is arranged upstream of the belt transport 12 in the sheet transporting direction and is located under the drum 13. The recording sheet P is fed onto the belt 15 so as to be transported on the belt 15 wrapping around the drum 13 by rotation of the gate rollers 17.

The gate rollers 17 correct a skew of the recording sheet P when the leading edge of the recording sheet P is struck against the surfaces of the gate rollers 17. In addition, the gate rollers 17 adjust the time at which driving of the rollers is started in order to feed the recording sheet P so as to mount the sheet onto a target position in the belt 15. The belt 15 has an endless form obtained by, for example, connecting both ends of the belt. The recording sheet P is fed so as not to be mounted on the joint of the belt 15.

The belt 15 is made of rubber. In this embodiment, the surface of the rubber belt has well-known adhesion properties such that the belt can hold the recording sheet P. Obviously, well-known electrostatic attraction or negative pressure suction, which will be described later, may be used to hold the recording sheet P on the surface of the belt 15.

A line recording type recording head (hereinafter, referred to as “line head”) 19K, serving as a recording member, is disposed above the drum 13 so as to face the outer curved surface of the drum 13. The line head 19K discharges ink droplets of black (K). The ink to be discharged is supplied from an ink tank (not shown) of black (K) ink through an ink supply tube to the line head 19K.

The line head 19K has a plurality of nozzles arranged in the direction intersecting (perpendicular to) the sheet transporting direction such that the length of arrangement of the nozzles allows for recording across a maximum width of the recording sheet P. Those nozzles simultaneously discharge a necessary amount of ink droplets to necessary portions in the recording sheet P, so that minute ink dots are formed in the recording sheet P. Consequently, recording in black for characters or an image to be recorded on the recording sheet P can be performed during only one pass in which the recording sheet P is allowed to once pass through a transport path between the line head 19K and the belt 15.

So long as the line head 19K includes a plurality of unit heads arranged in different positions in the direction (along the width of the recording sheet P) intersecting the sheet transporting direction such that printing across the whole width of the recording sheet P can be performed by the unit heads, at least some of the unit heads may be disposed in different positions in the sheet transporting direction.

Referring to FIG. 2, a magnetic linear encoder 20 is disposed on one side of the belt 15. The magnetic linear encoder 20 includes a magnetic linear scale 21 and a magnetic sensor 22. The magnetic linear scale 21 is disposed on the whole of the periphery of the side of the belt. The magnetic sensor 22 detects a magnetic pattern magnetized with a predetermined pitch on the magnetic linear scale 21 and reproduces the pattern. The magnetic sensor 22 outputs an encoder signal including pulses whose number is proportional to the amount of rotation of the belt 15. The printer 11 further includes a controller 23 serving as a control section. The controller 23 controls the electric motor 16 in accordance with the encoder signal supplied from the magnetic sensor 22 so as to drive the electric motor 16 at constant speed corresponding to a recording mode at that time. The controller 23 also controls ejection timing of ink droplets on the basis of a recording reference pulse (ejection timing signal) generated on the basis of the encoder signal through an internal circuit so that the ink droplets are ejected to the transported sheet in a proper position.

In FIGS. 1 and 2, the ratio of the diameters of the drum 13 and the roller 14 is schematically shown. The drum 13 actually has a diameter that is three to ten times as large as that of the roller 14. For example, when the diameter of the roller 14 is 3 cm, it is preferred that the diameter of the drum 13 range from 9 to 30 cm. The reason why the ratio of the diameters is set as described above is as follows: The large diameter of the drum 13 ensures a large inertia in order to obtain stable rotation and also ensures provision of an area for arrangement of the line head 19K performing printing on the outer curved surface of the drum.

The mass of the drum 13 also affects the inertia. It is therefore preferred to set the outer diameter of the drum 13 in consideration of the mass so that the motion of the belt 15 is significantly affected by the drum 13 rather than by the roller 14.

When the recording sheet P, transported on the belt 15, reaches the roller 14, the recording sheet P has to be removed from the belt 15. In this embodiment, the curvature of part, wrapping around the roller 14, of the belt 15 is determined so that the recording sheet P self-strips from the belt 15 due to the stiffness of the recording sheet P. The curvature of the belt 15 necessary for self-stripping of the recording sheet P is determined from the stiffness of the recording sheet P and the diameter of the roller 14 is then determined so as to obtain this curvature. Stripping pawls 24 for forcibly stripping the recording sheet P are disposed near a self-stripping position for the recording sheet P and downstream of the self-stripping position in the sheet transporting direction. The stripping pawls 24 are arranged in the direction along the width of the belt 15. The stripping pawls 24 are come into contact with parts of the recording sheet P, which does not perform self-stripping, in the direction along the width of the sheet, thereby stripping the recording sheet P from the belt 15. The stripping pawls 24 may be arranged in the self-stripping position.

The structure of a line printer (hereinafter, simply referred to as “printer”) 111, serving as the first rear-side recording unit 1B, will be described below. The first rear-side recording unit 1B also has a belt transport 112 having the same configuration as that of the belt transport 12 in the first front-side recording unit 1A. The belt transport 112 has a driving drum (hereinafter, referred to as “drum”) 113 disposed on the upstream side in the sheet transporting direction, a driven roller (hereinafter, referred to as “roller”) 114 placed on the downstream side in the sheet transporting direction, and an endless belt (hereinafter, simply referred to as “belt”) 115 stretched between the drum 113 and the roller 114. A rotating shaft 113a of the drum 113 and a rotating shaft 114a of the roller 114 are rotatably supported by bearings (not shown) respectively.

The printer 111 further has a line head 119K corresponding to the line head 19K and stripping pawls 124 corresponding to the stripping pawls 24. In addition, the printer 111 includes an electric motor corresponding to the electric motor 16, a magnetic linear encoder (including a magnetic linear scale and a magnetic sensor) corresponding to the magnetic linear encoder 20, and a controller corresponding to the controller 23. The electric motor, the magnetic linear encoder, and the controller in the printer 111 are not shown in FIG. 1.

Referring to FIG. 1, the recording sheet P transported while being held on the surface of the belt 15 of the first front-side recording unit 1A is transferred to the first rear-side recording unit 1B such that part, passed under the line head 19K, of the recording sheet P is transported onto part of the belt 115 of the first rear-side recording unit 1B, the part of the belt 115 being upstream of the line head 119K and wrapping around the drum 113 in the first rear-side recording unit 1B.

The second front-side recording unit 2A has the same structure as that of the first front-side recording unit 1A, except that a line head 19C of cyan (C) is included instead of the line head 19K. Accordingly, the same components are designated by the same reference numerals and explanation of those components is omitted. The second rear-side recording unit 2B has the same structure as that of the first rear-side recording unit 1B, except that a line head 119C of cyan (C) is included instead of the line head 119K. Accordingly, the same components are designated by the same reference numerals and explanation of those components is omitted.

The third front-side recording unit 3A has the same structure as that of the first front-side recording unit 1A, except that a line head 19M of magenta (M) is included instead of the line head 19K. Accordingly, the same components are designated by the same reference numerals and explanation of those components is omitted. The third rear-side recording unit 3B has the same structure as that of the first rear-side recording unit 1B, except that a line head 119M of magenta (M) is included instead of the line head 119K. Accordingly, the same components are designated by the same reference numerals and explanation of those components is omitted.

The fourth front-side recording unit 4A has the same structure as that of the first front-side recording unit 1A, except that a line head 19Y of yellow (Y) is included instead of the line head 19K. Accordingly, the same components are designated by the same reference numerals and explanation of those components is omitted. The fourth rear-side recording unit 4B has the same structure as that of the first rear-side recording unit 1B, except that a line head 119Y of yellow (Y) is included instead of the line head 119K. Accordingly, the same components are designated by the same reference numerals and explanation of those components is omitted. In the following description, the line heads 19Y, 19M, 19C, and 19K and the line heads 119Y, 119M, 119C, and 119K will be referred to as line heads 19 and 119 unless the different ink colors are especially distinguished from one another.

In the double-sided image forming apparatus with the above-described structure (i.e., including the first front-side recording unit 1A, the first rear-side recording unit 1B, the second front-side recording unit 2A, the second rear-side recording unit 2B, the third front-side recording unit 3A, the third rear-side recording unit 3B, the fourth front-side recording unit 4A, and the fourth rear-side recording unit 4B), when recording is started, a recording sheet P is fed from the gate rollers 17 onto the drum 13 disposed on the upstream side in the sheet transporting direction in the first front-side recording unit 1A in FIG. 1. The recording sheet P is mounted on the belt 15 such that the sheet is in tight contact with (or adheres to) the belt 15 due to the adhesion properties of the surface of the belt 15.

The belt 15 is driven by the force of the driving drum 13, so that the belt 15 rotates so as to follow the motion of the drum 13. Since the motion of the belt 15 depends on the drum 13, the motion of the recording sheet P mounted on the belt 15 also depends on the drum 13. The drum 13, which has the large inertia, stably rotates during rotating at constant speed. Even when a fluctuation in speed occurs in the driven roller, the rotation of the belt 15 on the drum 13 is stable. Accordingly, this fluctuation hardly causes vibration of the belt 15. Consequently, transport by the belt is remarkably stable, thus achieving high-speed and high-image-quality printing.

The orientation of the belt 15 depends on the drum 13 because the amount of wrap of the belt 15 around the drum 13 is larger than that around the roller 14. If a fluctuation in speed occurs in the driven roller having a smaller diameter, the belt 15 is stably rotated, so that the belt 15 hardly meanders.

Even when the belt 15 skews relative to the drum 13, the recording sheet P is moved so as to follow the drum 13 irrespective of the belt 15 interposing between the recording sheet P and the drum 13. In other words, even when the belt 15 skews relative to the drum 13 and the recording sheet P skews relative to the skewing belt 15, the recording sheet P is mounted on the belt 15 so as not to skew relative to the drum 13. Consequently, if the belt 15 on which the recording sheet P is mounted skews, the recording sheet P is stably transported so as to follow the drum 13 so long as the recording sheet P is fed onto the belt 15 on the drum 13 while being held in a correct orientation and position.

Since the line printer 11, serving as the first front-side recording unit 1A, is configured to perform recording using the line recording type line head 19K, the printer 11 carries out recording onto the front side of a recording sheet P while rotating the drum 13 at constant rotational speed. If the printer 11 uses a serial recording method, each time a serial recording head moves in the thrust direction of the drum for scanning, the drum having the large inertia alternates between driving and stopping. This results in a reduction in stop position accuracy of the drum. In contrast, in the use of the line head, since recording can be performed while the drum 13 is being rotated at constant speed, stable rotation of the drum 13 increases the transport position accuracy of a recording sheet P, so that high image quality recording can be performed on the recording sheet P. In this instance, recording is performed at high speed. Printing of one sheet of paper by the first front-side recording unit 1A is finished for a period of time (for example, 0.1 to 5 seconds) during which the drum 13 rotates once or twice.

The recording sheet P whose “front side” has been subjected to recording in black by the line head 19K is transported to a position corresponding to the roller 14 disposed on the downstream side of the sheet transporting direction in FIG. 1 while being mounted on the belt 15. The recording sheet P self-strips from the curved surface of the belt 15 in which the curvature significantly varies depending on the diameter of the roller 14 and is then transferred to the first rear-side recording unit 1B. The recording sheet P stuck on the belt 15 is bent so that the recording sheet P peels off (self-strips from) the belt 15 only due to the stiffness of the sheet. Thus, the recording sheet P is removed from the belt 15. If part of the recording sheet P does not self-strip, the part is peeled off by the stripping pawls 24.

As shown in FIG. 1, the recording sheet P, which has been transferred to the first rear-side recording unit 1B, is transported on part, wrapping around the drum 113, of the belt 115, the part being upstream of the line head 119K in the first rear-side recording unit 1B. The “rear side” of the recording sheet P is subjected to recording in black by the line head 119K and is then transported on the belt 115 to a position corresponding to the roller 114 on the downstream side in the sheet transporting direction in FIG. 1. In this position, the recording sheet P self-strips from the curved surface of the belt 115 in which the curvature of the belt 115 significantly varies depending on the diameter of the roller 114, alternatively, the recording sheet P is peeled off by the stripping pawls 124. After that, the recording sheet P is then transferred to the second front-side recording unit 2A.

In the second front-side recording unit 2A, the “front side” of the recording sheet P is subjected to recording in cyan through the line head 19C and the recording sheet P is then transferred to the second rear-side recording unit 2B. In the second rear-side recording unit 2B, the “rear side” of the recording sheet P is subjected to recording in cyan through the line head 119C and the recording sheet P is then transferred to the third front-side recording unit 3A.

In the third front-side recording unit 3A, the “front side” of the recording sheet P is subjected to recording in magenta through the line head 19M and the recording sheet P is then transferred to the third rear-side recording unit 3B. In the third rear-side recording unit 3B, the “rear side” of the recording sheet P is subjected to recording in magenta through the line head 119M and the recording sheet P is then transferred to the fourth front-side recording unit 4A.

In the fourth front-side recording unit 4A, the “front side” of the recording sheet P is subjected to recording in yellow through the line head 19Y and the recording sheet P is then transferred to the fourth rear-side recording unit 4B. In the fourth rear-side recording unit 4B, the “rear side” of the recording sheet P is subjected to recording in yellow through the line head 119Y. Consequently, recording on a color-by-color basis, i.e., recording in all of four ink colors on the recording sheet P is finished. The resultant recording sheet P self-strips from the curved surface of the belt 115, alternatively, the recording sheet P is peeled from the belt 115 by the stripping pawls 124 and is then ejected to the outside of the double-sided image forming apparatus.

As described in detail above, the first embodiment has the following advantages.

The “front side” and the “rear side” of a recording sheet are alternately subjected to recording in the four ink colors (black, cyan, magenta, and yellow) on the color-by-color basis through the first front-side recording unit 1A, the first rear-side recording unit 1B, the second front-side recording unit 2A, the second rear-side recording unit 2B, the third front-side recording unit 3A, the third rear-side recording unit 3B, the fourth front-side recording unit 4A, and the fourth rear-side recording unit 4B in the order of the front side, the rear side, the front side, and the rear side such that the first front-side recording unit 1A performs recording in black on the front side of the recording sheet, the first rear-side recording unit 1B performs recording in black on the rear side thereof, the second front-side recording unit 2A performs recording in cyan on the front side thereof, the second rear-side recording unit 2B performs recording in cyan on the rear side thereof, and so fourth.

Consequently, ink adhesion on both of the “front side” and the “rear side” of the recording sheet P can progress evenly, thus eliminating a cause of curling of the recording sheet and reducing the difference in recording quality between the “front side” and the “rear side” thereof.

Since the “front side” and the following “rear side” of the recording sheet P are subjected to recording in the same color, the front and rear sides, applied with the same color ink, e.g., black ink, of the recording sheet have the same degree of change in state, such as distortion or swelling, caused by the ink adhesion to the recording sheet, so that the changed states of the front and rear sides are easily cancelled out. Accordingly, when the “front side” of the recording sheet P is then subjected to recording with the cyan ink, the recording sheet P can be set in a condition close to the “both sides identical condition”. Advantageously, the difference in recording quality between the front and rear sides of the recording sheet P can be further reduced.

The fed recording sheet P is subjected to recording through the line heads 19 and 119 such that part, located above the stably rotating drum (13, 113) having the large diameter and large inertia, of the recording sheet is subjected to recording. Accordingly, recording can be performed at high recording position accuracy. In addition, since the line heads 19 and 119 are used as recording members, recording can be carried out while the drums 13 and 113 are being rotated at constant speed, thus improving the recording position accuracy. For example, if the serial recording method is used, the drums have to be driven intermittently. A reduction in stop position accuracy (or sheet transporting position accuracy) of each drum having the large inertia results in a reduction in recording accuracy. In contrast, since the line recording method is used in this embodiment, the drums 13 and 113 having the large inertia may be continuously driven at constant speed during recording without being stopped, the stop becoming a cause of reducing the recording position accuracy. The drums can be stably rotated, so that the high recording position accuracy can be ensured.

Since the belts 15 and 115 are used for transporting the recording sheet P, simple transport can be achieved by the belts 15 and 115. The recording sheet P is not mounted directly on the outer curved surface of the drum (13, 113). Although the recording sheet P is mounted on the belt (15, 115) wrapping around the drum (13, 113), part, on the belt (15, 115) wrapping around the outer curved surface of the drum (13, 113), of the recording sheet P follows the drum (13, 113). Advantageously, stable transportation of the recording sheet P can be achieved, thus leading to high image quality recording.

The rollers 14 and 114 each having a small diameter are arranged as rotating members paired with the drums 13 and 113 around which the belts 15 and 115 wrap, respectively. Advantageously, the recording sheet P, which has been subjected to recording, transported on the belt (15, 115) can easily self-strip from the curved portion of the belt (15, 115) at which the curvature of the belt increases depending on the roller (14, 114). Accordingly, the double-sided image forming apparatus does not need, for example, a complicated gripping mechanism, as disclosed in JP-A-2003-94615, for holding a recording sheet on the drum.

The diameter of each of the drums 13 and 113 is set to three to ten times that of each of the rollers 14 and 114. Advantageously, the inertia of each of the drums 13 and 113 can be ensured larger than that of each of the rollers 14 and 114 while an increase in size of the line printers 11 and 111 caused by the increase in size of the drums 13 and 113 is being prevented. Consequently, the stability of transporting the recording sheet P and the increased recording position accuracy for the recording sheet P can be achieved.

As for each belt 15 stretched between the drum 13 and the roller 14 and each belt 115 stretched between the drum 113 and the roller 114, even when the suspended part of the belt vibrates or the belt oscillates due to a fluctuation in speed of the corresponding roller having a small inertia every speed fluctuation cycle, such vibration or oscillation does not propagate through part, held on the belt wrapping around the drum, of the recording sheet P. Advantageously, this results in an increase in recording quality in double-sided recording.

### Second Embodiment

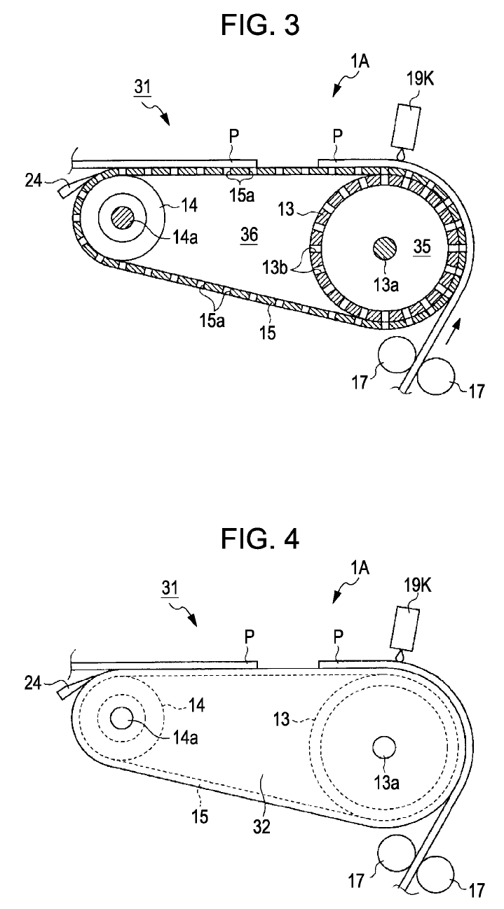

A double-sided image forming apparatus according to a second embodiment of the invention will be described with reference to FIGS. 3 to 5.

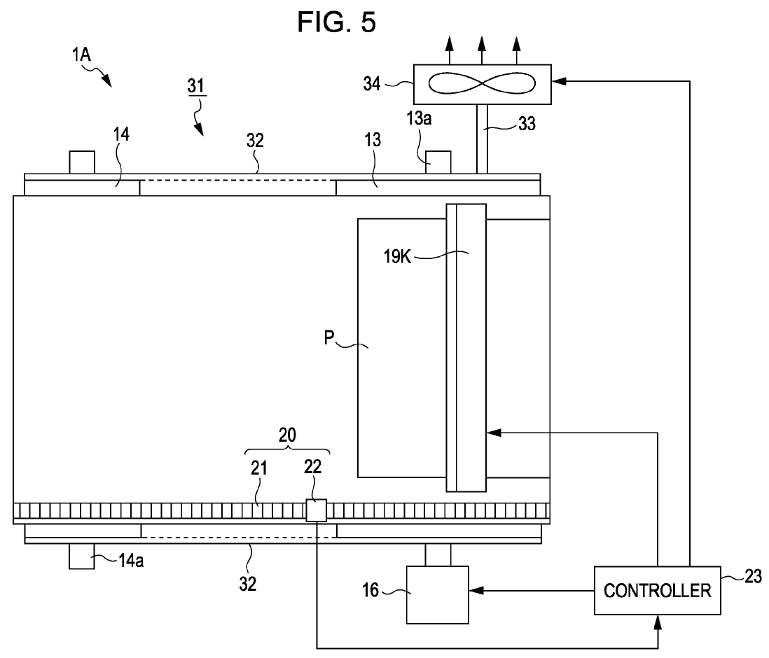

FIG. 3 is a schematic sectional side elevation view of a first front-side recording unit included in the double-sided image forming apparatus according to the second embodiment. FIG. 4 is a schematic side view of the first front-side recording unit. FIG. 5 is a plan view of the first front-side recording unit. In the double-sided image forming apparatus according to the second embodiment, a first rear-side recording unit, a second front-side recording unit, a second rear-side recording unit, a third front-side recording unit, a third rear-side recording unit, a fourth front-side recording unit, and a fourth rear-side recording unit basically have the same structure as that of the first front-side recording unit. Accordingly, those components are not shown in FIGS. 3 to 5 and explanation of the components is omitted.

A feature of the double-sided image forming apparatus according to the second embodiment is that negative pressure suction is used in belts, this feature being different from that of the first embodiment.

Referring to FIG. 3, a line printer (hereinafter, simply referred to as “printer”) 31, serving as the first front-side recording unit 1A, includes a drum 13. The drum 13 has many suction holes 13b such that the suction holes 13b are scattered over the whole outer curved surface of the drum 13. A belt 15 also has many suction holes 15a such that the suction holes 15a are scattered over the whole of the belt 15. The drum 13 and the belt 15 are configured so that at least some of the suction holes 13b of the drum 13 always communicate with at least some of the suction holes 15a of the belt 15 even when part, wrapping around the drum 13, of the belt 15 slightly shifts relative to the drum 13. For this purpose, for example, the suction holes 13b may be arranged at random in the drum 13 and the suction holes 15a may be arranged at random in the belt 15. Alternatively, the diameter of each suction hole in one of the drum 13 and the belt 15 may be larger than the diameter of each suction hole in the other one.

As shown in FIG. 4 and 5, both side faces (extending perpendicular to the drawing sheet of FIG. 5) of the printer 31 are closed by side plates 32 so that the air is not leaked out from the drum 13 excluding portions for emitting the air. A clearance between each side plate 32 and each of movable members, i.e., the drum 13, a roller 14, and the belt 15 is sealed with, for example, a contact seal or a well-known sealing member having a labyrinth structure.

Referring to FIG. 5, the side plate 32 (upper side plate in FIG. 5) is connected to one end of a pipe 33 that communicates with the internal space of the drum 13. The other end of the pipe 33 is connected to a fan 34. The controller 23 drives the fan 34, so that the air in a drum chamber 35, serving as the internal space of the drum 13, is sucked and discharged to the outside of the drum 13. Thus, the inside of the drum 13 is held at negative pressure. A belt chamber 36, serving as a substantially closed space, is enclosed by the two side plates 32, the drum 13, and the roller 14. The belt chamber 36 communicates with the inside of the drum 13 through the suction holes 13b. Therefore, when the inside of the drum 13 is held at negative pressure, the inside of the belt chamber 36 is also held at negative pressure.

The negative pressure in the belt chamber 36 causes suction air current flowing from the outer curved surface of the belt 15 through the suction holes 15a of the belt 15 to the belt chamber 36. A recording sheet P subjected to recording is transported on the belt 15 while being attracted to the upper surface of the belt 15 by suction. For example, when air current (wind) having a predetermined force is applied to a recorded portion, which has been subjected to recording, of the recording sheet on the upper portion of the belt 15, the recorded portion does not curl upward away from the upper surface of the belt 15 and the recording sheet is stably transported. Accordingly, a portion that is being or to be subjected to recording in the recording sheet P can be prevented from shifting relative to the drum 13 due to the curling of the recorded portion in the recording sheet P.

The recording sheet P is attracted onto the belt 15 by suction. Since the recording sheet P can be mounted onto the downwardly facing surface, located on the lower side in the direction of gravity, of the belt 15, gate rollers 17 are arranged under the drum 13 such that the distance between the drum 13 and the rollers 17 is longer than that in the first embodiment. Accordingly, the position at which the recording sheet P is fed to the drum 13 is shifted lower than that in the first embodiment relative to the outer curved surface of the drum 13, so that the amount of wrap of the recording sheet P around the drum 13 can be increased.

In the printer 31, the fan 34 is driven to discharge the air from the inside of the drum 13, thus causing air current flowing into the inside of the drum 13 through the suction holes 13b of the drum 13 and the suction holes 15a of the belt 15. Consequently, the recording sheet P is transported on the belt 15 while being attracted to the belt 15 by suction. Since the recording sheet P is prevented from shifting relative to the drum 13, the recording sheet P can be stably transported with high reliability.

When the recording sheet P is transported up to a position corresponding to the roller 14 located on the downstream side in the sheet transporting direction (left in FIG. 3), the suction holes 15a of part, wrapping around the roller 14, of the belt 15 are closed by the outer curved surface of the roller 14, so that suction force is not allowed to act on the recording sheet P on the belt 15. Consequently, the recording sheet P can be easily peeled from the belt 15 by elimination of the suction force due to closing the suction holes 15a and self-stripping of the recording sheet P due to the roller 14. Since stripping pawls (separation pawls) 24 are arranged in the same way as the first embodiment, even if a portion of the recording sheet P does not self-strip from the belt 15, the portion can be reliably peeled off by the stripping pawls 24.

The second embodiment has the following advantages.

The inside of the drum 13 is brought under negative pressure by driving the fan 34, so that the recording sheet P is attracted to part, wrapping around the drum 13, of the belt 15 by suction through the suction holes 13b of the drum 13 and the suction holes 15a of the belt 15. Consequently, the recording sheet P can be more reliably prevented from shifting relative to the drum 13. Advantageously, the high recording position accuracy for the recording sheet P can be maintained.

The belt chamber 36 communicating with the inside (i.e., the drum chamber 35) of the drum 13 through the suction holes 13b is also brought under negative pressure. Accordingly, the recording sheet P, which has been subjected to recording, can be transported while being attracted to the belt 15 by suction. Furthermore, since the suction holes 15a of the belt 15 are closed by the outer curved surface of the roller 14 in a zone where the recording sheet P self-strips, suction force does not act on the recording sheet P on the belt 15, so that the recording sheet P can easily self-strip.

Since the recording sheet P is attracted to the belt 15 by suction, the recording sheet P can be mounted on the downwardly facing surface of the belt 15 against gravity. Accordingly, the amount of wrap of the belt 15 around the outer curved surface of the drum 13 and the amount of wrap (or the length of wrap) of the recording sheet P around the belt 15 can be ensured to be large (or long) in the direction along the circumference of the drum 13. Thus, an arrangement area for the line head 19 which should be arranged so as to face a portion, around which a recording sheet P wraps, of the outer curved surface of the drum 13 can be provided such that the length of the arrangement area in the direction along the circumference of the drum 13 is long. Advantageously, when it is necessary to arrange many line heads 19 because the number of ink colors is increased to five or more, such an arrangement area can be ready for the many line heads 19. In a case where the number of line heads is not increased, the flexibility in selection of the arrangement position of the line head 19 can be increased.

### Third Embodiment

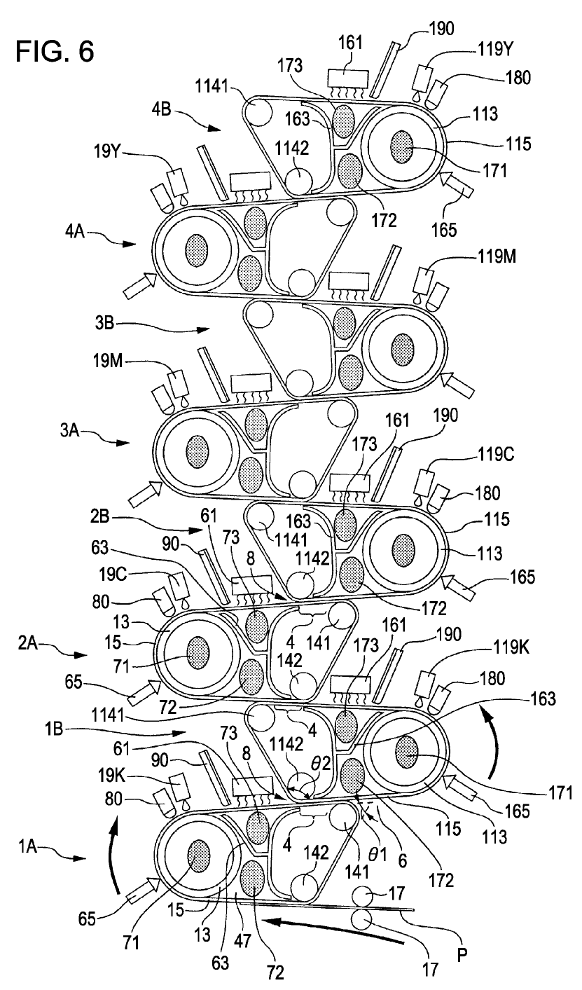

A double-sided image forming apparatus according to a third embodiment of the invention will be described with reference to FIG. 6. FIG. 6 is a schematic sectional side elevation view of the double-sided image forming apparatus according to the third embodiment.

Referring to FIG. 6, like as the double-sided image forming apparatuses according to the foregoing embodiments, the double-sided image forming apparatus according to this embodiment includes a first front-side recording unit 1A, a first rear-side recording unit 1B, a second front-side recording unit 2A, a second rear-side recording unit 2B, a third front-side recording unit 3A, a third rear-side recording unit 3B, a fourth front-side recording unit 4A, and a fourth rear-side recording unit 4B in the sheet transporting direction in which a recording sheet P is transported, those units being of the line recording type.

In this embodiment, the four front-side recording units 1A, 2A, 3A, and 4A each include one drum 13 and two rollers. Similarly, the four rear-side recording units 1B, 2B, 3B, and 4B each include one drum 113 and two rollers. Specifically, the four front-side recording units 1A, 2A, 3A, and 4A each include a first roller 141 and a second roller 142 and the four rear-side recording units 1B, 2B, 3B, and 4B each include a first roller 1141 and a second roller 1142. In other words, each recording unit has a three-axis structure.

The first front-side recording unit 1A and the first rear-side recording unit 1B will be described below. Since the second front-side recording unit 2A, the third front-side recording unit 3A, and the fourth front-side recording unit 4A have the same structure as that of the first front-side recording unit 1A and the second rear-side recording unit 2B, the third rear-side recording unit 3B, and the fourth rear-side recording unit 4B have the same structure as that of the first rear-side recording unit 1B, the same components as those of the first front-side recording unit 1A and the first rear-side recording unit 1B are designated by the same reference numerals and explanation of those units 2A, 2B, 3A, 3B, 4A, and 4B is omitted.

A transfer section 4 where a recording sheet P is to be transferred between the units is provided by surface contact between a belt 15 of the first front-side recording unit 1A and a belt 115 of the first rear-side recording unit 1B, the surface contact having a predetermined area extending in the sheet transporting direction.

The transfer section 4 is located between the first roller 141, serving as a section 6 that separates a recording sheet P, in the first front-side recording unit 1A and the second roller 1142, serving as a section 8 that receives the recording sheet P, in the first rear-side recording unit 1B. An angle θ₁ formed by the belt 15 wrapping around the first roller 141, serving as the separating section 6, is an acute angle. An angle θ₂ formed by the belt 115 wrapping around the second roller 1142, serving as the receiving section 8, is an obtuse angle.

In this embodiment, a halogen lamp, serving as a drying section 61, is disposed between a line head 19K of the first front-side recording unit 1A and the second roller 1142, serving as the receiving member 8, in the first rear-side recording unit 1B. In addition, a protective barrier 90 that protects heat transfer is disposed near the drying section 61 so as to be located upstream from the drying section 61. Instead of the halogen lamp, the drying section 61 may include a light dryer, such as a xenon lamp, a mercury lamp that emits ultraviolet light curing UV curable ink, or an LED lamp. Alternatively, heat of radiation, a current of normal temperature air, or a current of warm air approximately ranging from 60 to 250° C. may be used.

The first front-side recording unit 1A further includes a first negative pressure section 71 that attracts a recording sheet P to at least part, wrapping around the drum 13, of the belt 15 by negative pressure suction. The first negative pressure section 71 includes suction holes 13b and 15a, a pipe 33, a fan 34, and two side plates 32 similar to those in the second embodiment (FIG. 3), those components of the section 71 being not shown in FIG. 6.

The first front-side recording unit 1A further includes a second negative pressure section 72 and a third negative pressure section 73 in a space 47 that is provided on the inside of the belt 15 and on the outside of the drum 13. The second negative pressure section 72 attracts a recording sheet P to the outer surface of part, located upstream of the part wrapping around the drum 13, of the belt 15 by negative pressure suction. The third negative pressure section 73 attracts the recording sheet P to the outer surface of part, located downstream of the part wrapping around the drum 13, of the belt 15 by negative pressure suction.

The third negative pressure section 73 is separated from the first negative pressure section 71 and the second negative pressure section 72 by a partition 63. In this embodiment, the partition 63 is disposed so that the first negative pressure section 71 and the second negative pressure section 72 are brought under negative pressure by negative pressure generated due to discharge of a gas into the drum 13 through the suction holes (13b) of the drum 13 and suction force is generated through the suction holes (15a) in the part, upstream of the other part wrapping around the drum 13, of the belt 15. The space 47 enclosed by the partition 63 and the belt 15 is substantially hermetically sealed.

A sensor 65 for detecting the position of a recording sheet P is disposed upstream of the line head 19K. The sensor 65 detects the leading edge of the recording sheet P and the first front-side recording unit 1A can perform recording on the recording sheet P. Advantageously, recording on the “front side” of the sheet can be performed with high recording position accuracy.

In this embodiment, a belt speed sensor 80 is disposed near the line head 19K so as to be located upstream of the line head 19K. The belt speed sensor 80 determines actual speed of the belt 15 so that ink discharge timing can be controlled at high accuracy.

The structure of the first rear-side recording unit 1B is the same as that of the first front-side recording unit 1A. The first front-side recording unit 1A carries out recording on the “front side” of a recording sheet P. In contrast, the first rear-side recording unit 1B carries out recording on the “rear side” thereof. Accordingly, the same components, constituting the first rear-side recording unit 1B, as those of the unit 1A are designated by the same reference numerals and explanation of the components of the unit 1B is omitted.

The third embodiment has the following advantages.

According to this embodiment, each transfer section 4 for a recording sheet P is provided by surface contact between the belts 15 and 115 of the adjacent recording units, for example, the first front-side recording unit 1A and the first rear-side recording unit 1B (or the first rear-side recording unit 1B and the second front-side recording unit 2A, or the second front-side recording unit 2A and the second rear-side recording unit 2B, . . . ), the surface contact having a predetermined area extending in the sheet transporting direction. Accordingly, in each transfer section 4, the front and rear sides of a recording sheet P are supported by the belts 15 and 115. After that, the recording sheet P is shifted from such a both sides supported mode to a single side supported mode in which one side of the sheet is held only by the belt 115 of the first rear-side recording unit 1B disposed downstream of the transfer section 4. Consequently, the recording sheet P is smoothly transferred from, for example, the belt 15 of the first front-side recording unit 1A to the belt 115 of the first rear-side recording unit 1B, thus preventing a reduction in recording quality caused by sheet transfer between the adjacent recording units.

In addition, the first front-side recording unit 1A, the first rear-side recording unit 1B, the second front-side recording unit 2A, the second rear-side recording unit 2B, the third front-side recording unit 3A, the third rear-side recording unit 3B, the fourth front-side recording unit 4A, and the fourth rear-side recording unit 4B each include the one drum (13 or 113) and the two rollers (141 and 142 or 1141 and 1142), i.e., each have the three-axis structure. Advantageously, the flexibility in design of the entire structure can be increased. Consequently, a space for arrangement of other components, e.g., drying sections 61 and 161 and sensors 65 and 165, can be easily ensured.

The transfer section 4 is located between, for example, the first roller 141, serving as the section 6 for separating a recording sheet P, in the first front-side recording unit 1A and the second roller 1142, serving as the section 8 for receiving the recording sheet P, in the first rear-side recording unit 1B. The angle θ₁ formed by the belt 15 wrapping around the first roller 141, serving as the separating section 6, is the acute angle. The angle θ₂ formed by the belt 115 wrapping around the second roller 1142, serving as the receiving section 8, is the obtuse angle. Consequently, in a case where a recording sheet P, whose “front side” has been subjected to recording in the first front-side recording unit 1A, enters the transfer section 4 toward the first rear-side recording unit 1B, if the leading edge of the recording sheet P floats, the above-described obtuse-angle arrangement can easily eliminate the floating of the recording sheet P so that the recording sheet P enters the transfer section 4. After that, the recording sheet P can be easily separated from the belt 15 of the first front-side recording unit 1A in the exit of the transfer section 4 by the above-described acute-angle arrangement and be smoothly transported such that the sheet is held only by the belt 115 of the first rear-side recording unit 1B.

In this embodiment, one recorded side of each recording sheet P is dried by the drying section (61, 161) and, after that, the other side thereof is subjected to recording. Accordingly, a reduction in recording quality can be prevented.

Each recording sheet P is attracted to at least part, wrapping around the drum (13, 113), of the belt (15, 115) by suction under negative pressure generated by the first negative pressure section (71, 171). Consequently, the recording sheet P can be effectively prevented from shifting relative to the outer curved surface of the drum (13, 113) driven stably. Advantageously, shifting of the recording sheet P relative to the drum (or belt) can be effectively prevented, thus easily obtaining high recording position accuracy.

For example, the first front-side recording unit 1A and the first rear-side recording unit 1B each have the second negative pressure section (72, 172) and the third negative pressure section (73, 173) for attracting a recording sheet P to the outer surface of the belt (15, 115). Accordingly, the recording sheet P can be transported while being held on the belt (15, 115) and be smoothly transferred between the recording units.

Each third negative pressure section (73, 173) is separated from the corresponding first negative pressure section (71, 171) and the corresponding second negative pressure section (72, 172) through the partition (63, 163). In particular, therefore, in the arrangement of the components including the drying section (61, 161), heat applied to the belt (15, 115) for drying can be eliminated by suction exhaust stream, serving as a negative pressure generating source of the third negative pressure section (73, 173), so that the heat is not propagated toward the drum (13, 113). Consequently, unnecessary heat can be prevented from propagating to the drum (13, 113). Thus, any trouble, such as nozzle clogging, caused by propagation of unnecessary heat through a recording head located near the drum (13, 113) can be prevented.

### Other Embodiment

The above-described embodiments have been described with respect to the double-sided image forming apparatus for performing recording with inks of four different colors. However, the number of ink colors is not limited to four. The number of ink colors may be adequately set. For example, three colors, six colors, or eight colors may be used. The number of combination of the front-side recording unit and the rear-side recording unit may be increased or decreased depending on the number of ink colors, so that the double-sided image forming apparatus can be easily ready for multi-color recording. As a matter of course, the order of colors is not limited to that (black→cyan→magenta→yellow) in the foregoing embodiments.

The invention may be applied to a recording apparatus for ejecting a pretreatment liquid or an overcoat liquid instead of ink.

The above-described embodiments have been described with respect to the double-sided image forming apparatus in which a recording medium is transported by the belts while being transferred between the recording units. A transporting member is not limited to a belt. A transporting member using a roller or a guide may be used.

The invention is not limited to an ink jet printer. The invention may be applied to a thermal transfer printer and may also be applied to a copy machine.

A fluid-ejecting image forming apparatus is not limited to an ink jet printer. The apparatus may be embodied as a fluid ejecting apparatus that ejects or discharges a fluid other than ink, the fluid including a liquid, a liquid state material containing particles of a functional material dispersed therein or mixed therewith, a fluid state material, such as gel, or a solid material, such as a powder and granular material including toner, capable of flowing as a fluid and being ejected.

The invention may be applied to, for example, a liquid state material ejecting apparatus that ejects a liquid state material containing a dispersed or dissolved material, such as an electrode material or a coloring material (pixel material) used in manufacture of a liquid crystal display, an electroluminescent (EL) display, or a surface emission display, a liquid ejecting apparatus that ejects liquid of transparent resin, such as UV curable resin, onto a substrate to form a micro hemispherical lens (optical lens) used in an optical communication element, a liquid ejecting apparatus that ejects an acidic or alkaline etching solution to etch a substrate, and a fluid state material ejecting apparatus that ejects a fluid state material, such as gel (e.g., physical gel).

Predetermined patterns (including a wiring pattern, an electrode pattern, a pixel pattern, an etching pattern, and an arrangement pattern), each of which is formed by landing an ejected fluid on a recording medium, such as a substrate, in the above-described apparatuses are included in images formed by recording in this specification. The term “fluid” conceptually excludes a fluid composed of only gas and includes, for example, a liquid (e.g., an inorganic solvent, an organic solvent, a solution, a liquid resin, or a liquid metal (metal melt)), a powder and granular material, or a fluid state material.

What is claimed is:

1. A double-sided image forming apparatus comprising:
front-side image forming units and rear-side image forming units arranged in the transporting direction in which a recording medium is transported, wherein each of the front-side image forming units and the rear-side image forming units includes:
an endless belt that transports the recording medium; and
a recording section that performs recording on the recording medium transported on the belt,
the recording medium held and transported on the belt of one of the adjacent front-side image forming unit and rear-side image forming unit is transferred to the other image forming unit such that part, passed under the recording section of the one image forming unit, of the recording medium is transported onto part of the belt of the other image forming unit, the part of the belt being upstream of the recording section of the other image forming unit,
the recording section of each of the front-side image forming units and the rear-side image forming units is configured to perform recording in a single color, and
the front-side image forming units and the rear-side image forming units are arranged so that the front side and the rear side of the recording medium are alternately subjected to recording on a color-by-color basis in the order of the front side, the rear side, the front side, and the rear side.

2. The apparatus according to claim 1, wherein each front-side image forming unit and the following rear-side image forming unit are configured to perform recording on the front and rear sides of the recording medium in the same color.

3. The apparatus according to claim 1, wherein
each of the front-side image forming units and the rear-side image forming units includes:
a drum;
a roller having a smaller diameter than the drum;
the endless belt stretched between the drum and the roller;
a driving source that rotates the drum to rotate the belt; and
the recording section of a line recording type, the recording section facing the outer curved surface of the drum so as to perform recording on the recording medium held on part, wrapping around the drum, of the belt, and
the recording medium held and transported on the belt of one of the adjacent front-side image forming unit and rear-side image forming unit is transferred to the other image forming unit such that part, passed under the recording section of the one image forming unit, of the recording medium is transported onto part of the belt of the other image forming unit, the part of the belt being upstream of the recording section of the other image forming unit and wrapping around the drum of the other image forming unit.

4. The apparatus according to claim 3, wherein a transfer section where the recording medium is transferred between the adjacent image forming units is provided by surface contact between the belts of the adjacent front-side image forming unit and rear-side image forming unit, the surface contact having a predetermined area extending in the transporting direction.

5. The apparatus according to claim 4, wherein
all of the rear-side image forming units disposed downstream of at least the most upstream front-side image forming unit and the other front-side image forming units are each configured such that the number of drums is one and the number of rollers is two,
the transfer section is disposed between the roller, serving as a separating section that separates the recording medium, in one of the adjacent image forming units and the roller, serving as a receiving section that receives the recording medium, in the other image forming unit, and
an angle formed by the belt wrapping around the roller, serving as the separating section, is an acute angle and an angle formed by the belt wrapping around the roller, serving as the receiving section, is an obtuse angle.

6. The apparatus according to claim 5, further comprising:
a drying section disposed between the recording section of one of the adjacent image forming units and the roller, serving as the receiving section, of the other image forming unit.

7. The apparatus according to claim 3, further comprising:
a first negative pressure section that attracts the recording medium to at least part, wrapping around the drum, of the belt by negative pressure suction, wherein
each of the front-side image forming units and the rear-side image forming units includes a second negative pressure section and a third negative pressure section in a space provided on the inside of the belt and on the outside of the drum, the second negative pressure section attracting the recording medium to the outer surface of part, located upstream of the part wrapping around the drum, of the belt by negative pressure suction, the third negative pressure section attracting the recording medium to the outer surface of part, located downstream of the part wrapping around the drum, of the belt by negative pressure suction,
the third negative pressure section is separated from the first and second negative pressure sections through a partition, and
a space enclosed by at least the partition and the belt is substantially hermetically sealed.

8. The apparatus according to claim 1, wherein each image forming unit further includes a sensor that detects the position of the recording medium such that the sensor is disposed upstream of the recording section.

9. A double-sided image forming apparatus for discharging different kinds of liquids to each of the front and rear sides of a recording medium to form images, the apparatus comprising:
a first discharging unit that discharges one of the liquids to the front side of the recording medium;
a second discharging unit that discharges one of the liquids to the rear side of the recording medium processed through the first discharging unit;
a third discharging unit that discharges one of the liquids to the front side of the recording medium processed through the second discharging unit, the one liquid being not discharged by the first discharging unit; and
a fourth discharging unit that discharges one of the liquids to the rear side of the recording medium processed through the third discharging unit, the one liquid being not discharged by the second discharging unit.

10. A double-sided image forming method for discharging different kinds of liquids to the front and rear sides of a recording medium to form images, the method comprising the steps of:
(a) discharging one of the liquids to the front side of the recording medium;
(b) discharging one of the liquids to the rear side of the recording medium processed in step (a);
(c) discharging one of the liquids to the front side of the recording medium processed in step (b), the one liquid being not discharged in step (a); and
(d) discharging one of the liquids to the rear side of the recording medium processed in step (c), the one liquid being not discharged in step (b).
